(19) United States
(12) Patent Application Publication
(10) Pub. No.: US 2020/0358218 A1
(43) Pub. Date: Nov. 12, 2020

(54) ELECTRIC SOCKET WITH TOLERANCE COMPENSATION

(71) Applicant: Amphenol-Tuchel Electronics Gmbh, Heilbronn (DE)

(72) Inventors: Christian Ungerer, Untergruppenbach-Unterheinriet (DE); Wolfgang Kerner, Erlenbach (DE)

(73) Assignee: Amphenol-Tuchel Electronics Gmbh, Heilbronn (DE)

(21) Appl. No.: 16/765,766

(22) PCT Filed: Nov. 20, 2018
(86) PCT No.: PCT/EP2018/081978

§ 371 Date: May 20, 2020

(30) Foreign Application Priority Data
Nov. 21, 2017 (DE) 10 2017 127 439.1

(51) Int. Cl. H01R 13/11; H01R 24/76

(52) U.S. Cl. CPC H01R 13/112; H01R 24/76; H01R 13/111

(57) ABSTRACT

The invention relates to an electric socket which is easy to mount and provides a secure connection; the contact pin is slidably mounted in the socket, thereby allowing tolerance compensation.

The invention relates to an electric socket.

Various implementations of electric plug connections made of electric plugs and electric sockets are known from prior art. The socket must often times have a narrow tolerance to be able to be conductively connected to the plug and to be able to provide the contact to the terminal at the assembly location within said tolerance. If the connection is to be provided by means of a connection with material continuity, such as welding, both the contact to the plug and the contact to the welding location must be produced safely, fast and conductive, which, in praxis, most often is not the case.

The underlying object of the invention is therefore to provide a cost-effective and easy to mount electric socket, which safely and reliably produces both the conductive connection to the plug and to the terminal point in an easy to mount manner.

This object is solved according to the combination of features according to patent claim 1.

An electric plug not pertaining to the invention comprises a contact body housing, on which is formed a latching element movable in an unlatch direction, and a contact body latched-in in the contact body housing by means of a counter latching element, on which contact body is formed a counter latching element. The latching element of the contact body housing is at least partially surrounded and/or directly covered by a protection sleeve in an unlatch direction, wherein an inner surface of the protection sleeve is spaced apart to an outer surface of the movable latching element of the contact body housing in an unlatch direction. The distance is less than a latch distance in the unlatch direction, which must be traveled to unlatch the latching element between its latched-in position and the unlatch position of the latching element in the unlatch direction, to detach the latching element from the counter latching element of the contact body.

In an implementation variant not pertaining to the invention, the protection sleeve is integrally formed by a plug housing. The integral implementation of the protection sleeve and plug housing of the plug reduces the number of components and thus assembly and manufacturing costs.

Further, the inner surface of the plug housing has a decreasing inner diameter, at least in sections viewed opposite to the plug direction of the plug. The decreasing inner diameter serves as a ramp, on which a surface of the latching element facing to the outside glides along during assembly.

According to the invention an electric socket for a plug is suggested. The socket comprises a socket housing and a contact pin. The socket housing forms a feed-through, the inner surface of which forms a slide bearing surface of a bearing for the contact pin, wherein the contact pin has an outer surface in an axial direction, which is a counter bearing with respect to the sliding surface. The contact pin is fixated by means of the slide bearing surface and the outer surface in the radial direction and is supported axially movably in a direction of a longitudinal axis, which extends along an extension direction. A stop is arranged at the contact pin to limit the movement of the contact pin.

An embodiment variant is advantageous, where the stop is attached to an attachment area of the contact pin, which is located outside of the socket housing. The stop is implementable as a plate, in this case, which is fixated on a base of the pin.

The stop of the electric socket arranged in and/or at an assembly housing, forms an electric contact point in an advantageous embodiment variant. The contact point is connected to a counter contact point formed or arranged in or at the assembly housing in an electrically conductive manner, wherein an electrically conductive connection is preferably implemented with material continuity. In order for the counter contact point to remain stationary, the stop at the contact pin can be displaced in such a way that the stop abuts directly on the counter contact point.

In a further advantageous development, a longitudinal movement of the stop and the contact pin along the longitudinal axis is limited by a limitation surface formed by the socket housing and a limitation element spaced apart therefrom by a displacement path.

The limitation element is advantageously formed by the socket housing.

It is further advantageous that, in one implementation variant, the limitation element forms a latch-on element. The stop latches onto a guide rail by means of the latch-on element, so that the stop can move between the limitation element and the limitation surface. In doing so, the guide rail is formed movable at least in part, so that the latch-on element formed at the guide rail at the end facing away from the socket is movable in a direction essentially orthogonal to the guide rail or is movable flexibly.

An electric plug connection not pertaining to the invention comprises an electric plug and an electric socket. The electric plug and the electric socket comprise a socket housing, a contact body housing, at which at least one counter latch hook is formed, and a plug housing, at which at least one latching bracket is formed for latching with the counter latch hook. The contact body housing is at least partially surrounded by the plug housing, which fixates and/or limits the contact body housing in a radial movement with respect to the plug housing. The counter latching hook is formed to engage with the latching bracket. In a plugged-in state, in which a contact body is connected to a contact pin in an electrically conductive manner, an unlatching of the latching bracket and the latching hook is blocked by a protection surface.

In an embodiment variant not pertaining to the invention, the contact body housing is at least partially surrounded by the socket housing in the plugged-in state. The contact body housing is at least partially surrounded by the socket housing in the plugged-in state in, wherein the protection surface, which is formed at the socket housing, blocks a relative movement of the counter latching hook and the latching bracket with respect to one another in a radial direction and wherein the protection surface surrounds the plug housing at least partially in a radial direction.

Furthermore, in a design variant not pertaining to the invention, the latching bracket in the non-plugged in state can be detached from engagement with the counter latching hook. This facilitates a simple and fast disassembly.

The above disclosed features can be combined as desired insofar this is technically possible, and they are not contradictory to one another.

Other advantageous further developments of the invention are characterized in the dependent claims or are illustrated in more detail below together with the description of the preferred implementation of the invention by means of the figures. In the figures:

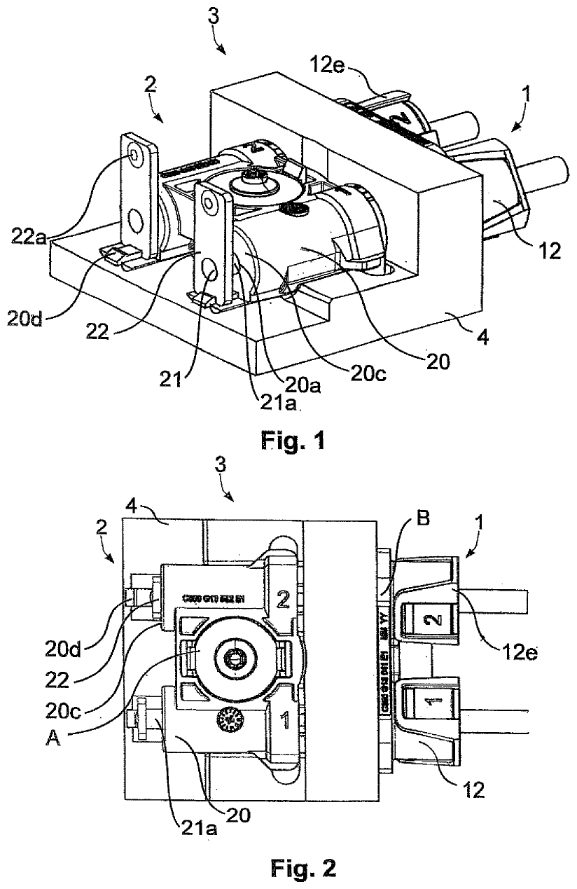

FIG. 1 shows a schematic spatial illustration of an electric plug connection;

FIG. 2 shows a schematic top view of an electric plug connection;

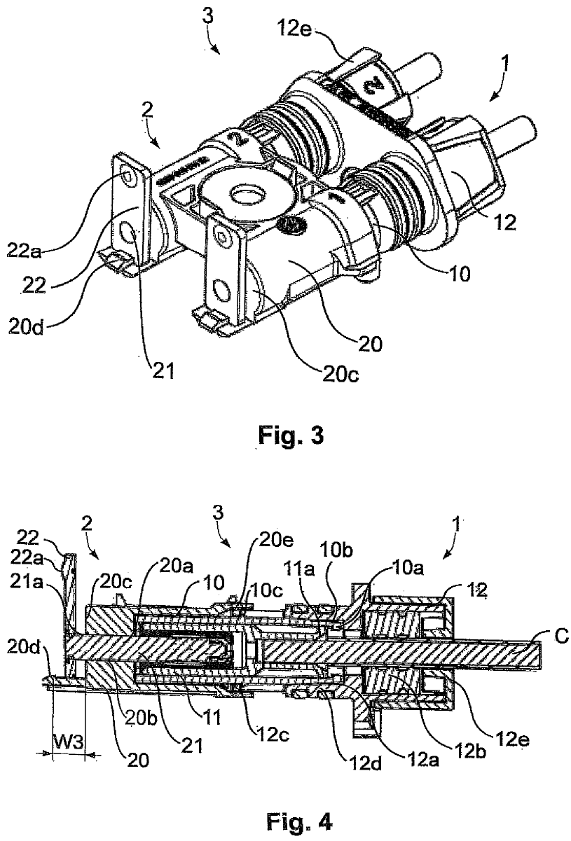

FIG. 3 shows a schematic spatial illustration of an electric plug connection;

FIG. 4 shows a cross-sectional view through an electric plug connection.

The Figures are exemplary schematic. The same reference numerals in the Figures indicate the same functional and/or structural features.

FIG. 1 shows a schematic spatial illustration of an electric plug connection 3. The electric socket 2 is affixed in an assembly housing 4 which is illustrated only partially, wherein it penetrates the assembly housing 4 only in part. The electric plug 1 is plugged into the electric socket 2. Only the plug housing 12 having the plug lid 12e can be discerned looking at plug 1 in FIG. 1. One side of the socket housing 20 forms the limitation surface 20c, which simultaneously serves as stop surface. Feed-through 20a is arranged in the center of the limitation surface 20c, through which feed-through the contact pin 21 is fed. The outer surface 21a forms a slide bearing surface. Stop 22 is affixed at the base of the contact pin 21, which stop is contacted by a counter contact point in the assembly housing 4 by means of its contact point 22a. Stop 22 is guided on a guide rail between the limitation surface 20c and the limitation element 20d, so that a distance between the contact point 22a and counter contact point can be balanced.

FIG. 2 shows an electric plug connection 3 as in FIG. 1 from top view, whereby the same components as in FIG. 1 are visible. The top view makes the fact that there are two electric plug connections particularly well discernible, which connections are arranged next to one another and are connected via bridges A, B on the socket and plug sides, respectively.

FIG. 3 shows an electric plug connection 3 similar to FIG. 1. The same components as in FIG. 1 are shown, except for the assembly housing 4.

FIG. 4 shows an electric plug connection 3 in cross-section, whereby, aside from the components of the electric plug 1, the cooperation with the electric socket 2 is shown, as well. The slide bearing surface 20b guides the contact pin 21 by its outer surface 21a through the feed-through 20a. The contact body 11 encloses the contact pin 21 at least in part and thus establishes the conductive connection from conductor C via the conductive contact body 11, conductive contact pin 21 and conductive stop 22 to the conductive electric contact point 22a. An unlatching of the latching bracket 12c in the plugged-in state is prevented in that the latching bracket 12c is surrounded at least in part by the protection surface 20e, whereby a movement of the snap bracket 12c in an unlatch direction is prevented.

The invention is not limited in its implementation to the above illustrated preferred embodiment examples. Rather, a number of variants is conceivable, which makes use of the illustrated solution even in case of fundamentally different implementations. For example, the socket could not be surrounded by an assembly housing but be in contact with an electrically conductive feed.

### LIST OF REFERENCE NUMERALS

1 plug
2 socket
3 plug connection
4 assembly housing
10 contact body housing
10a latching element
10b outer surface
10c counter latch hook
11 contact body
11a counter latching element
12 plug housing
12a inner surface
12b sealing element
12c latching bracket
12d protection sleeve
12e plug lid
20 socket housing
20a feed-through
20b slide bearing surface
20c limitation surface
20d limitation element
20e protection surface
21 contact pin
21a outer surface
22 stop
22a contact point
A bridge
B bridge
C conductor
W3 displacement path

1. An electric plug connection having an electric socket for a plug, comprising:
a socket housing and a contact pin, the socket housing forms a feed-through, an inner surface of which forms a slide bearing surface of a slide bearing for the contact pin,
wherein the contact pin has an outer surface in a radial direction, which is a counter bearing with respect to the sliding surface,
wherein the contact pin is fixated in the radial direction by the slide bearing surface and the outer surface, and is supported axially movably in a direction of a longitudinal axis which extends along a plug-in direction, and
wherein a stop is arranged at the contact pin to limit the movement of the contact pin.

2. The electric socket according to claim 1, wherein the stop is attached at an attachment area of the contact pin, which is located outside of the socket housing.

3. The electric socket according to claim 1, wherein the stop of the electric socket arranged in or at an assembly housing forms an electrical contact point, wherein the contact point is connected to a counter contact point, which is formed in or at the assembly housing, in an electrically conductive manner, wherein an electrically conductive connection is implemented with material continuity.

4. The electric socket according to claim 3, wherein a longitudinal movement of the stop and the contact pin is limited along the longitudinal axis by a limitation surface formed by the socket housing and a limitation element spaced apart therefrom by a displacement path.

5. The electric socket according to claim 4, wherein that the limitation element is formed by the socket housing.

6. The electric socket according to claim 4, wherein the limitation element forms a latch-on element.
